(19) United States
(12) Patent Application Publication
(10) Pub. No.: US 2011/0305503 A1
(43) Pub. Date: Dec. 15, 2011

(54) JOINT ASSEMBLY ON FRONT FRAME TUBE OF BABY STROLLER

(75) Inventor: CHIN-FENG LIN, TAINAN CITY (TW)

(73) Assignee: APEX BABY PRODUCTS INC., TAINAN (TW)

(21) Appl. No.: 13/005,708

(22) Filed: Jan. 13, 2011

(30) Foreign Application Priority Data
Jun. 11, 2010 (CN) 201020229265.6

(51) Int. Cl. F16C 11/10

(52) U.S. Cl. 403/93

(57) ABSTRACT

A joint assembly on a front frame tube of a baby stroller is revealed. The front frame tube includes an upper tube part and a lower tube part while the joint assembly consists of a first part, a second part and a connection part. The first part and the second part are respectively sleeved and connected with the upper tube part and the lower tube part while the other end of the first part and of the second part is connected with the connection part. Moreover, a leaning support surface for leaning against the first and the second parts is formed in a slot of the connection part. Thus the upper and the lower tube parts are stopped by the leaning support surfaces when being extended while the first part and the second part are also supported. Therefore, the front frame tube is maintained and fixed in an extended state.

### BACKGROUND OF THE INVENTION

1. Fields of the Invention

The present invention relates to a joint assembly on a front frame tube of baby strollers, especially to a joint assembly having a simple structure and able to fix as well as maintain the front frame tube in an extended state effectively.

2. Descriptions of Related Art

Baby strollers available on the market now are provided for parents to carry and move babies. Thus parents don't need to hold or carry babies by their arms all the time while going out. Moreover, babies can lean on the stroller comfortably. Furthermore, for easy transportation and storage of the stroller, the baby stroller is designed with a foldable structure. The present invention focuses on a joint assembly on a front frame tube of foldable baby strollers.

### SUMMARY OF THE INVENTION

Therefore it is a primary object of the present invention to provide a joint assembly that precisely supports and fixes the extended front frame tube of a baby stroller so that the stability of the baby stroller is enhanced after the stroller being extended.

In order to achieve above object, a joint assembly on a front frame tube of a baby stroller according to the present invention is provided. The front frame tube is divided an upper tube part and a lower tube part by the joint assembly. The joint assembly is composed of a first part, a second part and a connection part. The first part and the second part are respectively sleeved and connected with a corresponding end of the upper tube part and of the lower tube part. Moreover, the first part and the second part are respectively connected with each of two ends of the connection part. Furthermore, a leaning support surface for contacting and leaning against the first part as well as the second part is formed in a slot of the connection part that connects with the first part as well as the second part. Thus when the upper tube part and the lower tube part that form the front frame tube are extended, they are stopped by the leaning support surfaces of the connection part. Moreover, the first part and the second part are both supported by the leaning support surfaces of the connection part. Thus the front frame tube is further limited and fixed in an extended state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a side view of a baby stroller according to the present invention;

FIG. 2 is an explosive view of a joint assembly of baby strollers according to the present invention;

FIG. 3 is a side view of an assembled joint assembly of baby strollers according to the present invention;

FIG. 4 is a top view of an assembled joint assembly of baby strollers according to the present invention;

FIG. 5 is a side view of a folded baby stroller according to the present invention;

FIG. 6 is a side view of an assembled joint assembly of a folded baby stroller according to the present invention.

### DETAILED DESCRIPTION OF THE PREFERRED EMBODIMENT

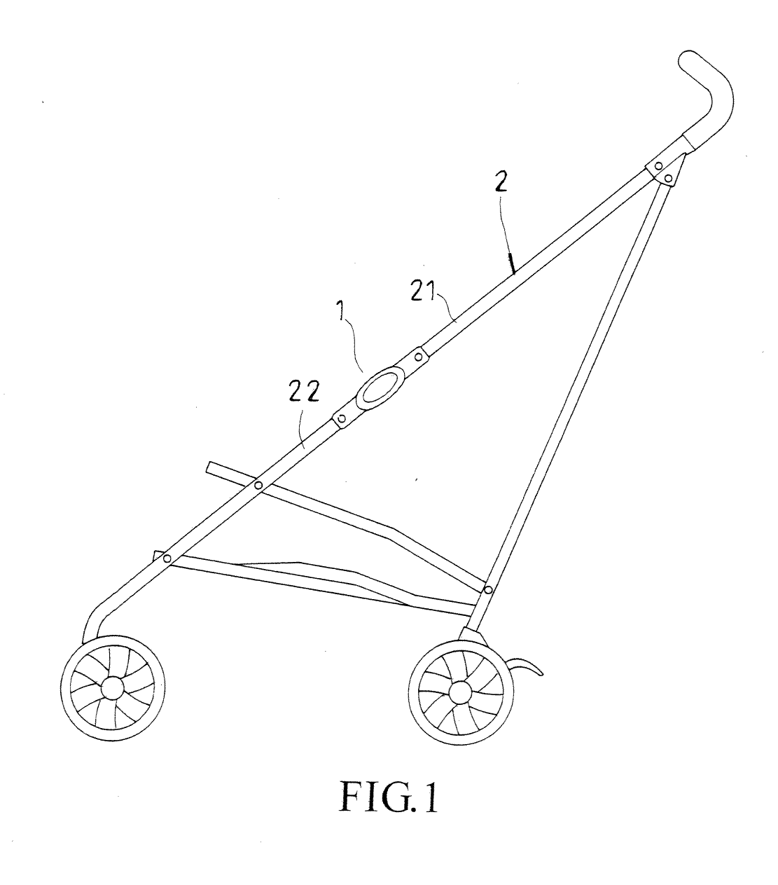

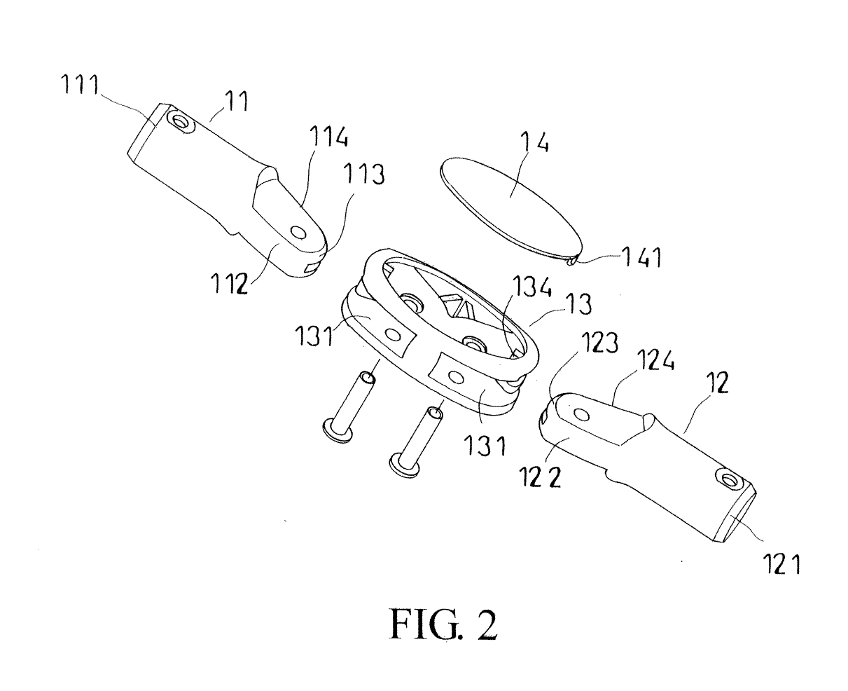

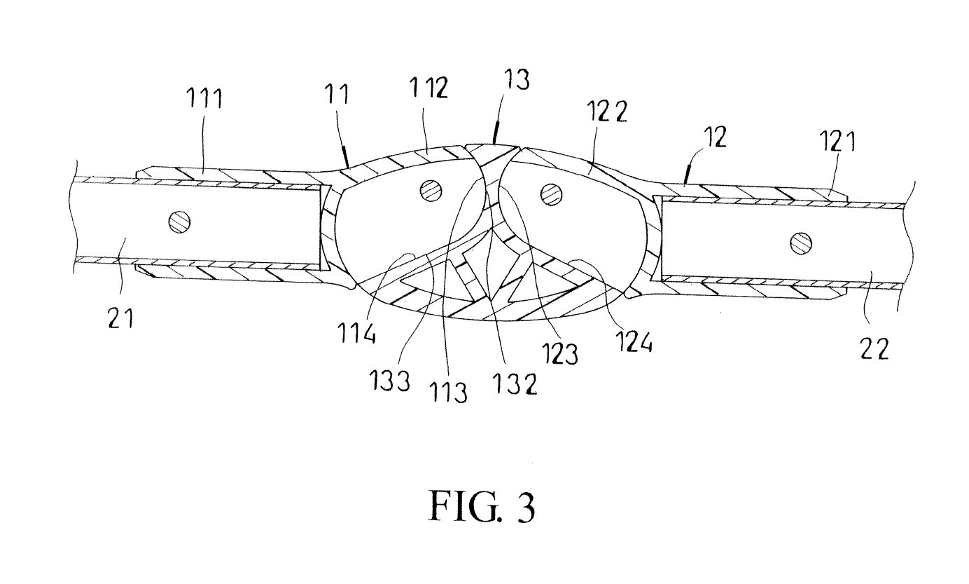

Refer to FIG. 1, a joint assembly on a front frame tube of a baby stroller according to the present invention is revealed. A joint assembly 1 is assembled on a front frame tube 2 of a baby stroller. The front frame tube 2 is divided into two parts—an upper tube part 21 and a lower tube part 22 by the joint assembly 1. The joint assembly 1 consists of a first part 11, a second part 12 and a connection part 13, as shown in FIG. 2. A first end 111 of the first part 11 as well as a first end 121 of the second part 12 is with a sleeve groove, respectively sleeved and connected with the upper tube part 21 and the lower tube part 22 while a second end 112 of the first part 11 and a second end 122 of the second part 12 are respectively pivoted to the connection part 13. Each of the second ends 112, 122 of the first part 11 and the second part 12 is provided with a contact surface respectively formed by an arc portion 113, 123 of the second end 112, 122 and a contact portion 114, 124 extended from the arc portion 113, 123. A slot 131 is arranged at each of two ends of the connection part 13. Refer to FIG. 3, a leaning support surface is formed by an arc portion 132 and a support portion 133 connected with each other, inside the slot 131. The arc portions 132 and the support portions 133 are disposed correspondingly to the arc portions 113, 123 and the contact portions 114, 124 of the first part and of the second part 12.

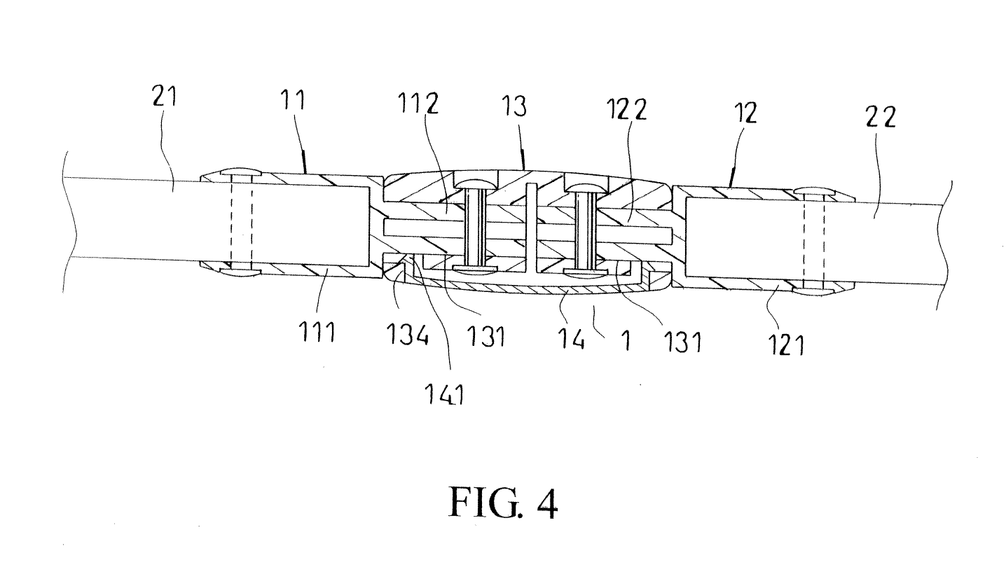

While assembling, refer to FIG. 3 and FIG. 4, the upper tube part 21 and the lower tube part 22 respectively are sleeved into the sleeve grooves on the first ends 111, 121 of the first part 11 and of the second part 12 and then to be fastened and fixed. Next the second end 112 of the first part 11 and the second end 122 of the second part 12 are respectively inserted into the slot 131 on each end of the connection part 13 to be assembled and pivoted. Thus the arc portions 132 and the support portions 133 are arranged correspondingly to the arc portions 113, 123 and the contact portions 114, 124 of the first part and of the second part 12.

Thereby when the baby stroller is in an extended state, the upper tube part 21 and the lower tube part 22 respectively assembled with the first end 111 of the first part 11 and at the first end 121 of the second part 12 are fixed firmly and maintained in an extended state precisely by the arc portions 113, 123 and the contact portions 114, 124 on the second end 112 of the first part 11 and on the second end 122 of the second part 12 contacting and leaning against the arc portions 132 and support portions 133 in the slots 131 of the connection part 13.

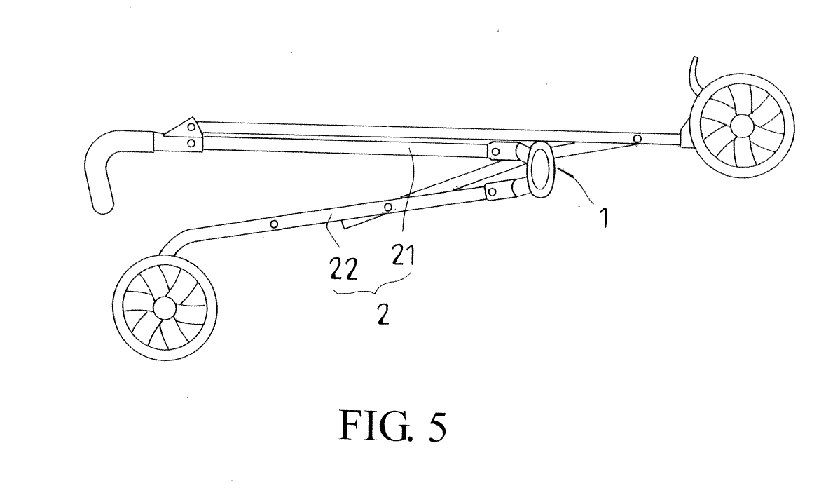

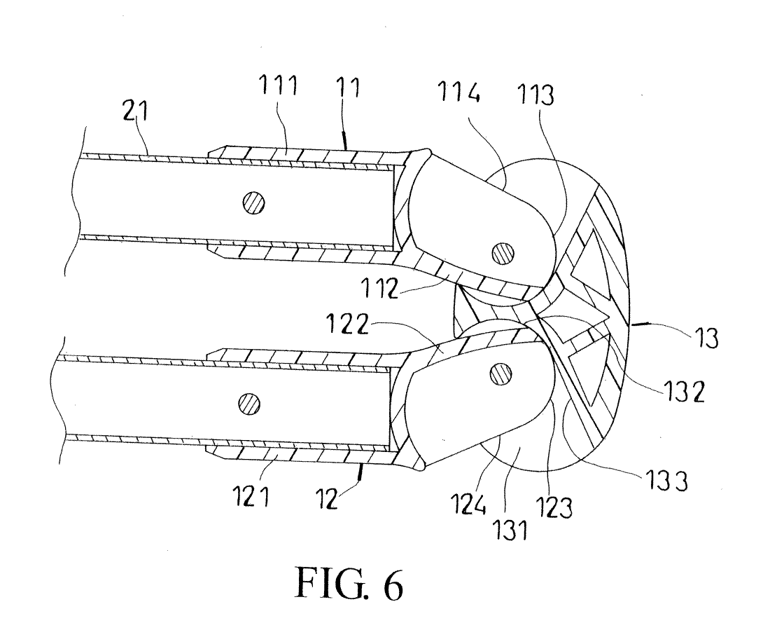

Refer to FIG. 5 and FIG. 6, when the baby stroller is folded, the folding is smooth and easy due to the arc portions 113, 123 on the second ends 112, 122 of the first part 11 and the second part 12, and the corresponding arc portions 132 arranged in the slots 131 of the connection part 13.

Refer to FIG. 2 and FIG. 4, the joint assembly on the front frame tube of the baby stroller further includes a decorative cover 14 assembled on an outer surface of the connection part 13 of the joint assembly. The outer surface of the connection part 13 is disposed with a locking slot 134 while the decorative cover 14 is arranged with a locking hook 141 that is corresponding to the locking slot 134. By the locking hook 141 inserted through and locked into the locking slot 134, the decorative cover 14 is fixed on the outer surface of the connection part 13.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A joint assembly on a front frame tube of a baby stroller comprising:
a first part, a second part and a connection part; wherein the front frame tube having an upper tube part and a lower tube part while the joint assembly is arranged between the upper tube part and the lower tube part; a first end of the first part and a first end of the second part are respectively connected with the upper tube part and the lower tube part; a second end of the first part and a second end of the second part are respectively pivoted to the connection part; a contact surface is formed on an edge of the second end of the first part as well as of the second part and a leaning support surface corresponding to the contact surface is formed in a slot of the connection part.

2. The device as claimed in claim 1, wherein the contact surface is formed by an arc portion and a contact portion extended from the arc portion while the leaning support surface is formed by an arc portion and a support portion connected with each other.

3. The device as claimed in claim 2, wherein a decorative cover is disposed on an outer surface of the connection part of the joint assembly.

4. The device as claimed in claim 3, wherein a locking slot is arranged at the outer surface of the connection part while the decorative cover is disposed with a locking hook that is corresponding to and locked into the locking slot.

5. The device as claimed in claim 1, wherein a decorative cover is disposed on an outer surface of the connection part of the joint assembly.

6. The device as claimed in claim 5, wherein a locking slot is arranged at the outer surface of the connection part while the decorative cover is disposed with a locking hook that is corresponding to and locked into the locking slot.
